(19) United States
(12) Patent Application Publication
(10) Pub. No.: US 2025/0259050 A1
(43) Pub. Date: Aug. 14, 2025

(54) MACHINE LEARNING TECHNIQUES FOR SYNTHESIZING MULTI-MODAL DATASETS

(71) Applicant: Optum, Inc., Minnetonka, MN (US)

(72) Inventors: Brian Lawrence Hill, Culver City, CA (US); Josue Nassar, Syosset, NY (US); Robert Elliott Tillman, Long Island City, NY (US); Eran Halperin, Santa Monica, CA (US); Matthew Dowling, Coram, NY (US)

(21) Appl. No.: 18/436,562

(22) Filed: Feb. 8, 2024

(51) Int. Cl. G06N 3/08; G06N 3/0455

(52) U.S. Cl. CPC G06N 3/08; G06N 3/0455

(57) ABSTRACT

Various embodiments of the present disclosure provide methods, apparatus, systems, computing devices, computing entities, and/or the like for receiving training data comprising data records with identified presence of modalities, training a multi-modal generative model based on the training data, and imputing missing modalities of input data records using the multi-modal generative model, wherein the multi-modal generative model comprises (i) a modality-agonistic latent variable encoder and (ii) one or more modality-specific latent variable encoders configured to receive output of the modality-agonistic latent variable encoder as input.

### BACKGROUND

Various embodiments of the present disclosure address technical challenges related to data imputation and provide solutions to address the efficiency and reliability shortcomings of existing generative machine learning models.

In certain applications, such as in the healthcare setting, data records may comprise data that is heterogeneous, complex, and multi-modal (e.g., comprising structured data such as diagnosis and procedure codes, lab results, medication orders, and unstructured but high-dimensional data such as medical images, clinical notes, or genomic data). Often times, data records may not comprise each of a plurality of available modalities, but rather a subset of the plurality of available modalities. However, when developing machine learning model applications, such as disease onset or progression prediction, it may be desirable to maximize a number of modalities to be observed, such as in training data, to leverage as much data as possible to accurately model features from the training data.

Traditional generative models, such as variational autoencoders (VAEs) may capture the latent (or hidden) low-dimensional structure of high-dimensional data across several modalities. While such traditional generative models may learn modality-agnostic latent structures captured across modalities, they (a) are not scalable to more than two modalities, (b) fail to capture modality-specific latent structures, and (c) ignore modality-specific latent structures when imputing unobserved modalities.

Various embodiments of the present disclosure make important contributions to traditional generative model techniques by addressing these technical challenges, among others.

### BRIEF SUMMARY

In general, various embodiments of the present disclosure provide methods, apparatus, systems, computing devices, computing entities, and/or the like for analyzing different data modalities expressed within data records.

Various embodiments of the present disclosure make important technical contributions to predictive multi-modal data imputation techniques that address the shortcomings of existing generative machine learning models. As described herein, often one or more modalities are missing from data records. For example, data records associated with patients that have two different modalities may comprise historical data reflective of real-valued numbers, such as a vector of lab results, and binary numbers, such as a vector of diagnosis codes. However, many data records may comprise only diagnosis codes and no lab results, and thus be considered to have only one modality. Accordingly, by capturing information shared across different modalities, the techniques described herein improve the computational efficiency, storage-wise efficiency, and/or speed of training predictive machine learning models.

In some embodiments, a computer-implemented method comprises receiving, by one or more processors, training data comprising a plurality of data elements that comprise (i) a plurality of data values associated with a plurality of training modalities and (ii) a plurality of modality observation variables that each identify an observation of a training modality for a data element of the plurality of data elements; generating, by the one or more processors and using a modality-agnostic latent variable encoder of a multi-modal generative machine learning model, one or more modality-agnostic latent variables based on the plurality of data values; generating, by the one or more processors and using a modality-specific latent variable encoder of the multi-modal generative machine learning model, one or more modality-specific latent variables based on the plurality of modality observation variables and the one or more modality-agnostic latent variables; generating, by the one or more processors and using a loss function, a loss for the multi-modal generative machine learning model based on the one or more modality-agnostic latent variables and one or more modality-specific latent variables; and initiating, by the one or more processors, the performance of one or more training operations based on the loss.

In some embodiments, a computing system comprises memory and one or more processors communicatively coupled to the memory, the one or more processors configured to receive training data comprising a plurality of data elements that comprise (i) a plurality of data values associated with a plurality of training modalities and (ii) a plurality of modality observation variables that each identify an observation of a training modality for a data element of the plurality of data elements; generate, using a modality-agnostic latent variable encoder of a multi-modal generative machine learning model, one or more modality-agnostic latent variables based on the plurality of data values; generate, using a modality-specific latent variable encoder of the multi-modal generative machine learning model, one or more modality-specific latent variables based on the plurality of modality observation variables and the one or more modality-agnostic latent variables; generate, using a loss function, a loss for the multi-modal generative machine learning model based on the one or more modality-agnostic latent variables and one or more modality-specific latent variables; and initiate the performance of one or more training operations based on the loss.

In some embodiments, a computer-implemented method comprises receiving, by one or more processors, an input data record comprising a plurality of input data elements; generating, by the one or more processors and via a multi-modal generative machine learning model that is applied to the input data record, one or more modality predictions based on (i) one or more modality-agnostic latent variables that are based on a plurality of data values associated with a plurality of training modalities and (ii) one or more modality-specific latent variables that are based on a plurality of modality observation variables and the one or more modality-agnostic latent variables; and initiating, by the one or more processors, the performance of one or more prediction-based actions based on the one or more modality predictions.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a flowchart diagram of an example process for analyzing modalities in data records in accordance with some embodiments of the present disclosure.

FIG. 5 is an example architecture of a multi-modal generative machine learning model in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

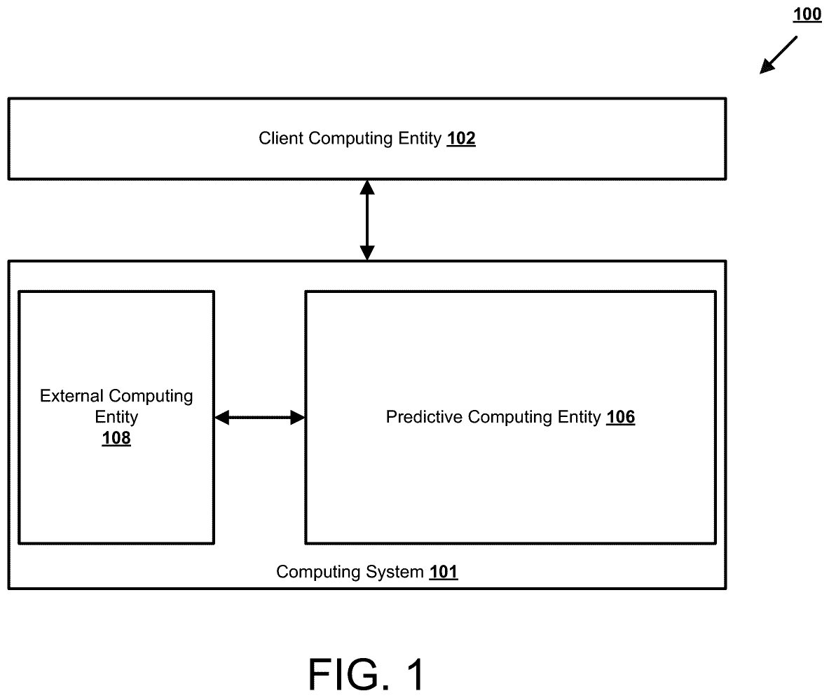

FIG. 1 provides an example overview of an architecture 100 in accordance with some embodiments of the present disclosure. The architecture 100 includes a computing system 101 configured to receive predictive data analysis requests from client computing entities 102, process the predictive data analysis requests to generate predictions, provide the generated predictions to the client computing entities 102, and automatically initiate performance of prediction-based actions based on the generated predictions. The example architecture 100 may be used in a plurality of domains and not limited to any specific application as disclosed herewith. The plurality of domains may include banking, healthcare, industrial, manufacturing, education, retail, to name a few.

An example of a prediction-based action that may be performed using the computing system 101 may comprise receiving a request for modality prediction (i.e., a predictive data analysis request), generating one or more modality predictions (e.g., imputing missing modalities or generating synthetic data records comprising synthetic modalities), and displaying the one or more modality predictions on a user interface. Other examples of prediction-based actions may comprise generating a diagnostic report, displaying/providing resources, generating, and/or executing action scripts, generating alerts or reminders, or generating one or more electronic communications based on the one or more modality predictions. In yet another example, a prediction-based action may comprise providing data records based on the one or more modality predictions to one or more of a downstream application, process, or machine learning model.

In accordance with various embodiments of the present disclosure, a predictive machine learning model may be trained to capture information shared across different modalities and generate accurate estimates of missing modalities given an observation of available modalities. As such, observed modalities of a data record may be leveraged to generate a prediction for a missing modality representative of an estimate of what the missing modality would be if present in the data record. This technique will lead to higher accuracy of performing predictive operations for missing data. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training predictive machine learning models.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive predictive data analysis requests from one or more client computing entities 102, process the predictive data analysis requests to generate predictions corresponding to the predictive data analysis requests, provide the generated predictions to the client computing entities 102, and automatically initiate performance of prediction-based actions based on the generated predictions.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or prediction operations of the present disclosure. In some examples, the external computing entities 108 may be configured to train, implement, use, update, and evaluate machine learning models in accordance with one or more training and/or prediction operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., data synthesis techniques, search techniques, and/or the like) described herein. The external computing entities 108, for example, may include and/or be associated with one or more entities that may be configured to receive, transmit, store, manage, and/or facilitate datasets, such as a dataset including a plurality of heterogeneous documents, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more prediction steps/operations of the present disclosure. In some examples, feedback (e.g., evaluation data, ground truth data, etc.) from the use the of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

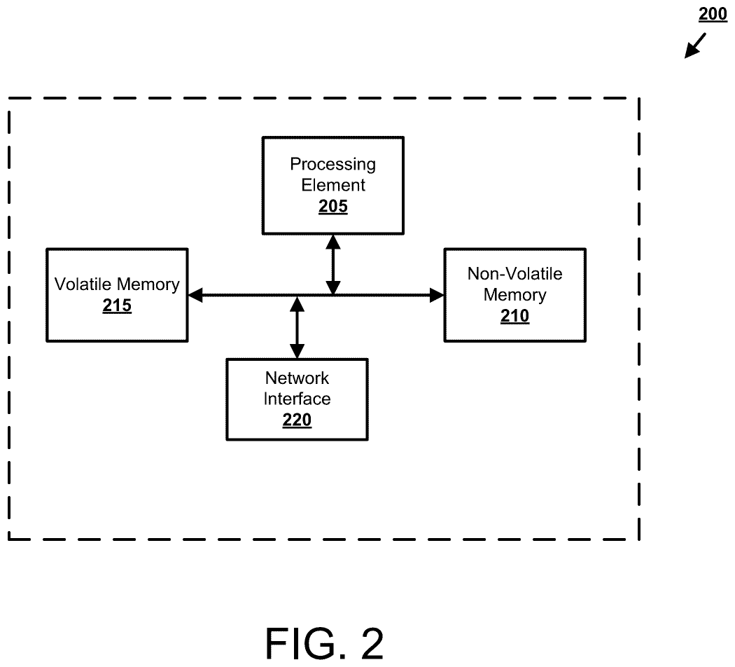

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning model(s) described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, code (e.g., source code, object code, byte code, compiled code, interpreted code, machine code, etc.) that embodiments one or more machine learning models or other computer functions described herein, executable instructions, and/or the like being executed by, for example, the processing element 205. Thus, the databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

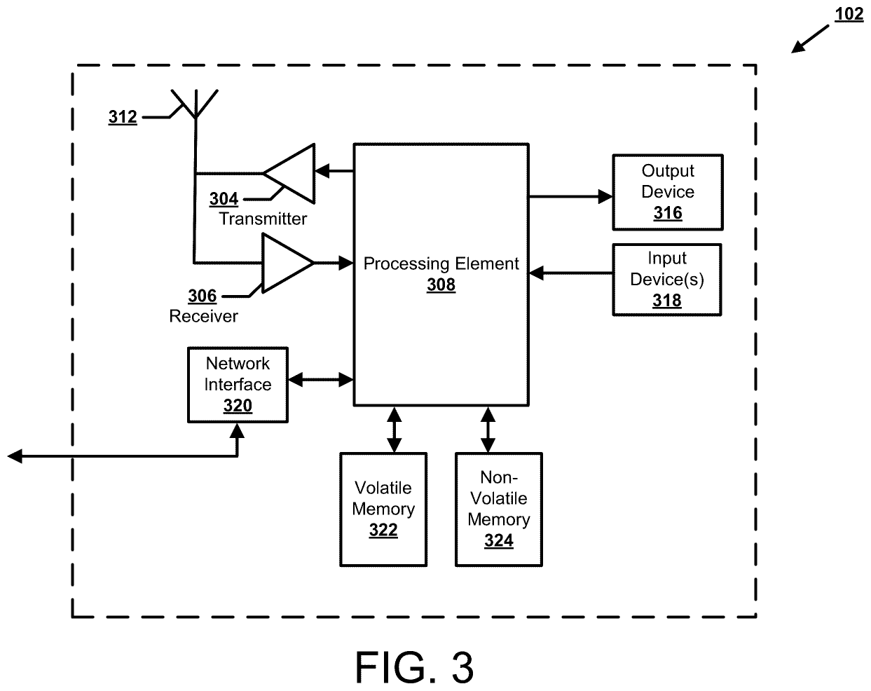

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. Examples of Certain Terms

In some embodiments, the term “training data” refers to data used to train a machine learning model to perform a desired prediction task. A machine learning model may generate one or more encodings by learning from (or training on) features associated with training data. For example, training data may comprise data including example associations between one or more features and respective one or more labels, wherein the one or more labels are associated with expected output of the trained machine learning model when provided with the one or more features. According to various embodiments of the present disclosure, training data comprises a plurality of data elements associated with one or more training data records, wherein a given one of the plurality of data elements comprises (i) a data value associated with one of a plurality of training modalities and (ii) a modality observation variable representative of an observation of the one training modality. In some example embodiments, training data may be extracted from or generated based on a corpus of structured data (e.g., electronic health record (EHR)/electronic medical records (EMR) or databases) comprising a plurality of data fields comprising codes, descriptions of diagnosis or action, times/dates, or other information.

In some embodiments, the term “modality” refers to a data construct that describes a type of data comprising a specific property. For example, a modality may characterize data associated with a given a context, data type (e.g., integers, characters, or strings), and/or file format (e.g., image, text, video, or audio). In some example embodiments, a data record associated with a status of a patient comprises a plurality of modalities (multi-modal), such as structured data including diagnosis and procedure codes, lab results, or medication orders, and unstructured high-dimensional data, such as medical images (e.g., computed tomography (CT), magnetic resonance imaging (MRI), or X-ray), clinical notes, or genomic data. Various embodiments of the present disclosure provide a multi-modal generative machine learning model that is trained to generate one or more modality predictions. Generating a modality prediction may comprise either imputing one or more modalities that are missing from an input data record or generating one or more synthetic data records comprising one or more synthetic modalities.

In some embodiments, the term “multi-modal generative machine learning model” refers to a data construct that describes parameters, hyperparameters, and/or defined operations of a machine learning model that is configured to generate one or more modality predictions. The one or more modality predictions may be generated by the multi-modal generative machine learning model based on one or more modality-specific latent variables and one or more modality-agnostic latent variables. The one or more modality-specific latent variables and the one or more modality-agnostic latent variables may be determined during training of the multi-modal generative machine learning model. In some embodiments, a multi-modal generative machine learning model comprises (i) a modality-agnostic latent variable encoder configured to generate one or more modality-agnostic latent variables based on training data and (ii) one or more modality-specific latent variable encoders configured to (a) receive the one or more modality-agnostic latent variables as input and (b) generate one or more modality-specific latent variables based on one or more modality observation variables (e.g., observed modalities) associated with a plurality of training data elements and the one or more modality-agnostic latent variables. In some embodiments, training the multi-modal generative machine learning model comprises generating one or more encodings that transform the training data into a lower-dimensional feature vector space. In some embodiments, training the multi-modal generative machine learning model further comprises optimizing a loss function. In some example embodiments, one or more encodings may be generated based on one or more modality-agnostic latent variables and one or more modality-specific latent variables, while optimizing a loss function. One or more modality predictions may be generated using the multi-modal generative machine learning model based on the one or more encodings. In some embodiments, a multi-modal generative machine learning model comprises a variational autoencoder architecture.

In some embodiments, the term “latent variable” refers to a data construct that describes an inferred feature that is generated based on an observation (e.g., by a machine learning model) of one or more features from training data. A latent variable may be representative of an underlying property used to encode one or more features that are learned during training of a machine learning model. In some embodiments, a latent variable is associated with a position within a feature vector space associated with an encoding. According to various embodiments of the present disclosure, a machine learning model, such as a multi-modal generative machine learning model, generates (i) one or more modality-agnostic latent variables based on training data and (ii) one or more modality-specific latent variables based on observed modalities associated with a plurality of training data elements and the one or more modality-agnostic latent variables.

In some embodiments, the term “modality-agnostic latent variable” refers to a data construct that describes an inferred feature that is shared across all modalities associated with a dataset. A modality-agnostic latent variable may be generated by a machine learning model, such as a multi-modal generative machine learning model, based on training data. In some embodiments, one or more modality-agnostic latent variables are used (in combination with one or more modality-specific latent variables) to generate encodings for generating modality predictions.

In some embodiments, the term “modality-specific latent variable” refers to a data construct that describes an inferred feature that is specific to a given modality associated with a dataset. A modality-specific latent variable may be generated by a machine learning model, such as a multi-modal generative machine learning model, based on observed modalities associated with a plurality of training data elements and one or more modality-agnostic latent variables. In some embodiments, one or more modality-specific latent variables are used to generate encodings for generating modality predictions. Modality-specific latent variables may allow a machine learning model to capture information relevant for a specific modality, leading to better reconstruction/generation of that modality. Modality-specific latent variables may also allow a machine learning model to better factorize information into modality-agnostic and modality-specific latent information, leading to better sharing of general modality-agnostic information across a plurality of modalities.

In some embodiments, the term “encoding” refers to a data construct that describes a latent representation of data comprising one or more features. For example, an encoding of data may be expressed as a vector comprising one or more numbers representative of one or more features associated with content of data. In some embodiments, an encoding may be generated by mapping or transforming one or more features to one or more elements in a feature vector space via one or more latent variables. According to various embodiments of the present disclosure, an encoding represents a feature associated with a modality.

In some embodiments, the term “observation” or “observe” refers to a presence of data or modality that may be identified by a machine learning model. For example, an input data record may comprise one or more observed modalities of a plurality of modalities that are present and one or more unobserved modalities of the plurality of modalities that are missing.

In some embodiments, the term “loss function” refers to a data construct that describes an objective parameter associated with generating a prediction output by a machine learning model. For example, a loss function may be optimized during training of a machine learning model. A loss function may be associated with a correctness of reconstructing input data based on features extracted from training data and encoded into a feature vector space, such as by a multi-modal generative machine learning model comprising an encoder-decoder (e.g., autoencoder) architecture. According to various embodiments of the present disclosure, training a machine learning model, such as a multi-modal generative machine learning model, comprises optimizing a modified evidence lower bound (ELBO) loss that is based on an impute loss to generate or impute data or modalities. In some embodiments, a loss function comprises one or more variables associated with one or more missing modalities. In some embodiments, a loss function is associated with imputation of missing modalities based on observed modalities.

In some embodiments, the term “modality prediction” refers to a data construct that describes an output generated by a multi-modal generative machine learning model. A modality prediction may comprise either an imputation of one or more missing modalities or one or more synthetic data records comprising one or more synthetic modalities. An imputation of a missing modality may comprise generating a modality that is representative of an estimate of the missing modality. A synthetic data record may comprise a data record representative of an example data record and estimates of one or more modalities that may be typical or expected, as determined by a trained multi-modal generative machine learning model. According to various embodiments of the present disclosure, modality predictions are generated based one or more encodings associated with a multi-modal generative machine learning model. In some embodiments, training the multi-modal generative machine learning model comprises generating the one or more encodings based on one or more modality-agnostic latent variables and one or more modality-specific latent variables, while optimizing a loss function.

In some embodiments, the term “impute” or “imputation” refers to a generation or reconstruction of data or modalities. For example, a data record may comprise one or more missing modalities that may be replaced, e.g., using a multi-modal generative machine learning model, with a modality prediction comprising one or more imputed modalities based on observed modalities (e.g., from training data).

### IV. Overview

Various embodiments of the present disclosure make important technical contributions to predictive multi-modal data imputation that address the shortcomings of existing generative machine learning models. For example, some techniques of the present disclosure improve the predictive accuracy and data coverage of generative machine learning models used to impute data missing from existing data records or generate new synthetic data records. To do so, some of the machine learning models of the present disclosure may be trained to generate predictions for one or more missing modalities within a dataset based on observed modalities with the dataset. By doing so, some of the techniques of the present disclosure improves, multi-modal, generative machine learning models that may handle multi-model dataset with improved predictive performance. As described herein, some of the techniques of the present disclosure provide training techniques for such models that improve training speeds and training efficiency, while improving the data coverage with respect to traditional generative modeling techniques.

It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative machine learning model architectures. Accordingly, some of the techniques of the present disclosure that improve predictive accuracy without harming training speed, such as the techniques described herein, enable improving training speed given an improved predictive accuracy. In doing so, some of the techniques described herein improve efficiency and speed of training predictive machine learning models, thus reducing the number of computational operations needed and/or the amount of training data entries needed to train predictive machine learning models. Accordingly, some of the techniques described herein improve the computational efficiency, storage-wise efficiency, and/or speed of training machine learning models, while improving the model's predictive performance.

Various embodiments of the present disclosure improve predictive accuracy of generative machine learning models by leveraging multiple, tiered, latent variables that both capture information shared across different modalities (e.g., a modality-agnostic latent variables, etc.) and information specific to each modality (e.g., modality-specific latent variables, etc.). For instance, a predictive machine learning model may be trained to capture information shared across different modalities and generate accurate estimates of missing modalities given an observation of available modalities. As such, observed modalities (e.g., diagnosis codes in a clinical example) of a data record may be leveraged to generate a prediction for a missing modality (e.g., lab results in a clinical example) representative of an estimate of what the missing modality would be if present in the data record (e.g., what lab results would for a patient data record with only diagnosis codes). By leveraging a combination of modality-agnostic and modality-specific latent variables, some techniques of the present disclosure may constrain predictions more closely to observed data. In this manner, some of the techniques of the present disclosure, improve accuracy of performing predictive operations for missing data as well as synthetic data.

In accordance with various embodiments of the present disclosure, predictions are generated for data records comprising one or more missing modalities. By doing so, data records comprising data or modalities that are missing from input data records but may be useful or required in downstream applications, processes, or machine learning models (e.g., disease onset or progression prediction), may be pre-processed and populated with estimated data or modalities. In this way, some of the techniques of the present disclosure may be practically applied to improve data imputation and, as a result, downstream tasks that rely on data imputation.

Examples of technologically advantageous embodiments of the present disclosure include: (i) prediction machine learning techniques that leverage observed modalities to generate missing modalities, (ii) modality-specific latent variable generation techniques for capturing modality-specific structures in a multi-modal generative machine learning model, (iii) machine learning training techniques for improving model accuracy while reducing computational resource usage, among others. Other technical improvements and advantages may be realized by one of ordinary skill in the art.

### V. Example System Operations

Various embodiments of the present disclosure comprise using a multi-modal generative model for data imputation (e.g., filling in missing data from a patient's data record) and synthetic data generation. For example, in a clinical context, patient records may have diagnosis codes, but lab results data may not be observed (e.g., exist in the patient records) for various systematic reasons. However, lab results data may contain valuable information about a patient's status and is therefore desirable to include as part of downstream machine learning modeling or analysis. As most traditional machine learning methods may require complete input data to be observed, it may be desirable to impute missing data as accurately and realistically as possible prior to processing or analysis by downstream machine learning models. Accordingly, the disclosed multi-modal generative machine learning model allows for imputing realistic data for missing modalities, thus improving downstream machine learning model training and inference.

As indicated, various embodiments of the present disclosure make important technical contributions to predictive multi-modal data imputation that address the shortcomings of existing generative machine learning models. By doing so, data records comprising data or modalities that are missing from input data records but may be useful or required in downstream applications, processes, or machine learning models (e.g., disease onset or progression prediction), may be pre-processed and populated with estimated data or modalities. In this way, some of the techniques of the present disclosure may be practically applied to improve data imputation.

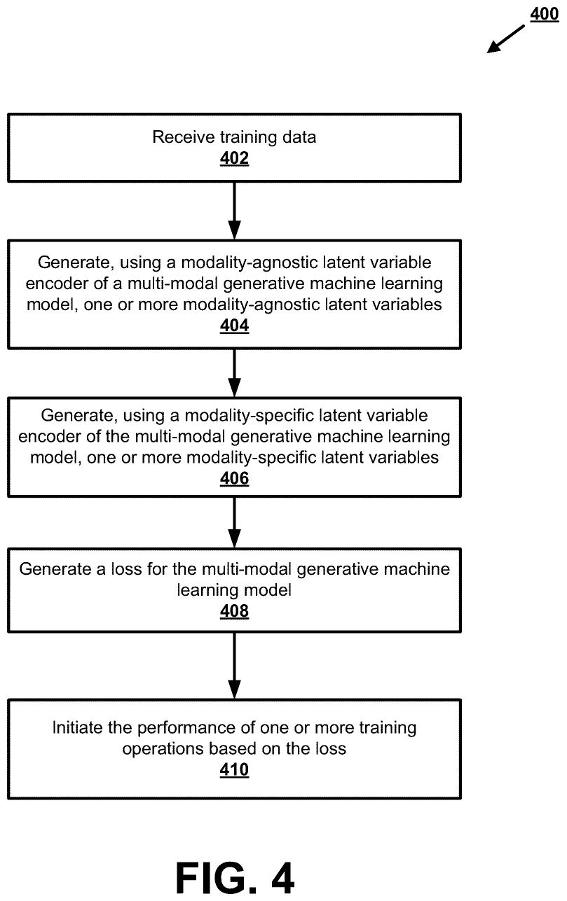

FIG. 4 is a flowchart diagram of an example process for analyzing modalities in data records in accordance with some embodiments of the present disclosure.

In some embodiments, via the various steps/operations of the process 400, the computing entity 200 may receive training data comprising data records to train a multi-modal generative machine learning model and use the multi-modal generative machine learning model to generate one or more modality predictions.

In some embodiments, the process 400 begins at step/operation 402 when the computing entity 200 receives training data comprising a plurality of data elements associated with one or more training data records.

In some embodiments, training data describes data used to train a machine learning model to perform a desired prediction task. A machine learning model may generate one or more encodings by learning from (or training on) features associated with training data. For example, training data may comprise data including example associations between one or more features and respective one or more labels, wherein the one or more labels are associated with expected output of the trained machine learning model when provided with the one or more features. In some example embodiments, training data may be extracted from or generated based on a corpus of structured data (e.g., EHR/EMR or databases) comprising a plurality of data fields comprising codes, descriptions of diagnosis or action, times/dates, or other information.

The plurality of data elements may comprise (i) a plurality of data values associated with a plurality of training modalities and (ii) a plurality of modality observation variables that each identify an observation of a training modality for a data element of the plurality of data elements.

In some embodiments, a modality describes a type of data comprising a specific property. For example, a modality may characterize data associated with a given a context, data type (e.g., integers, characters, or strings), and/or file format (e.g., image, text, video, or audio). In some example embodiments, a data record associated with a status of a patient comprises a plurality of modalities (multi-modal), such as structured data including diagnosis and procedure codes, lab results, or medication orders, and unstructured high-dimensional data, such as medical images (e.g., CT, MRI, or X-ray), clinical notes, or genomic data. Various embodiments of the present disclosure provide a multi-modal generative machine learning model that is trained to generate one or more modality predictions. Generating a modality prediction may comprise either imputing one or more modalities that are missing from an input data record or generating one or more synthetic data records comprising one or more synthetic modalities.

In some embodiments, training data comprises a K-tuple, and dimensions for each modality {(xⱼ, iⱼ)}ⱼ₌₁^{K}, where K may represent a number of modalities, xⱼ may represent data from modality j and iⱼ may comprise a binary variable that indicates whether the modality j is either observed or unobserved. For example, training data may comprise a patient data record comprising K=2 modalities—a vector of lab results and a vector of diagnosis codes, xⱼ comprising a real-valued number associated with a lab result or vector of diagnosis codes, and iⱼ comprising a binary number denoting presence/absence of the lab result or vector of diagnosis codes in the data record.

In some embodiments, an observation describes a presence of data or modality that may be identified by a machine learning model. That is, an input data record may comprise one or more observed modalities of a plurality of modalities that are present and one or more unobserved modalities of the plurality of modalities that are missing.

In some embodiments, at step/operation 404, the computing entity 200 generates, using a modality-agnostic latent variable encoder of a multi-modal generative machine learning model, one or more modality-agnostic latent variables based on the plurality of data values.

In some embodiments, a latent variable describes an inferred feature that is generated based on an observation (e.g., by a machine learning model) of one or more features from training data. A latent variable may be representative of an underlying property used to encode one or more features that are learned during training of a machine learning model. In some embodiments, a latent variable is associated with a position within a feature vector space associated with an encoding. According to various embodiments of the present disclosure, a machine learning model, such as a multi-modal generative machine learning model, generates (i) one or more modality-agnostic latent variables based on training data and (ii) one or more modality-specific latent variables based on observed modalities associated with a plurality of training data elements and the one or more modality-agnostic latent variables.

In some embodiments, a modality-agnostic latent variable describes an inferred feature that is shared across all modalities associated with a dataset. A modality-agnostic latent variable may be generated by a machine learning model, such as a multi-modal generative machine learning model, based on training data. In some embodiments, one or more modality-agnostic latent variables are used (in combination with one or more modality-specific latent variables) to generate encodings for generating modality predictions.

In some embodiments, a multi-modal generative machine learning model describes parameters, hyperparameters, and/or defined operations of a machine learning model that is configured to generate one or more modality predictions. The one or more modality predictions may be generated by the multi-modal generative machine learning model based on one or more modality-specific latent variables and one or more modality-agnostic latent variables. The one or more modality-specific latent variables and the one or more modality-agnostic latent variables may be determined during training of the multi-modal generative machine learning model.

In some embodiments, an encoding describes a latent representation of data comprising one or more features. For example, an encoding of data may be expressed as a vector comprising one or more numbers representative of one or more features associated with content of data. In some embodiments, an encoding may be generated by mapping or transforming one or more features to one or more elements in a feature vector space via one or more latent variables. According to various embodiments of the present disclosure, an encoding represents a feature associated with a modality.

In some embodiments, at step/operation 406, the computing entity 200 generates, using a modality-specific latent variable encoder of the multi-modal generative machine learning model, one or more modality-specific latent variables based on the plurality of modality observation variables and the one or more modality-agnostic latent variables.

In some embodiments, a modality-specific latent variable describes an inferred feature that is specific to a given modality associated with a dataset. A modality-specific latent variable may be generated by a machine learning model, such as a multi-modal generative machine learning model, based on observed modalities associated with a plurality of training data elements and one or more modality-agnostic latent variables. In some embodiments, one or more modality-specific latent variables are used to generate encodings for generating modality predictions. Modality-specific latent variables may allow a machine learning model to capture information relevant for a specific modality, leading to better reconstruction/generation of that modality. Modality-specific latent variables may also allow a machine learning model to better factorize information into modality-agnostic and modality-specific latent information, leading to better sharing of general modality-agnostic information across a plurality of modalities.

In some embodiments, at step/operation 408, the computing entity 200 generate, using a loss function, a loss for the multi-modal generative machine learning model based on the one or more modality-agnostic latent variables and one or more modality-specific latent variables.

In some embodiments, generating the multi-modal generative machine learning model further comprises optimizing a loss function. For example, one or more encodings may be generated based on one or more modality-agnostic latent variables and one or more modality-specific latent variables, while optimizing a loss function.

In some embodiments, a loss function describes an objective parameter associated with generating a prediction output by a machine learning model. For example, a loss function may be optimized during training of a machine learning model. A loss function may be associated with a correctness of reconstructing input data based on features extracted from training data and encoded into a feature vector space, such as by a multi-modal generative machine learning model comprising an encoder-decoder (e.g., autoencoder) architecture. According to various embodiments of the present disclosure, training a machine learning model, such as a multi-modal generative machine learning model, comprises optimizing a ELBO loss function, an impute loss function, or a combination thereof, to generate or impute data or modalities. In some embodiments, a loss function comprises one or more variables associated with one or more missing modalities. In some embodiments, a loss function is associated with imputation of missing modalities based on observed modalities.

According to some example embodiments, a multi-modal generative machine learning model is trained to impute missing modalities by optimizing the following loss function, [symbol] :

$$ℒ = {ℒ}_{elbo} + {ℒ}_{impute} \qquad Equation 1$$

[symbol] _{elbo} may comprise an ELBO loss function that incentivizes the multi-modal generative machine learning model to encode data into a lower-dimensional space, which may then be used to reconstruct the data or modality. In some embodiments, [symbol] _{elbo} may be determined by the following equation:

$${ℒ}_{elbo} = {𝔼}_{q ( {z}_{0} \vert {x}_{1 : K} )} [ {\sum }_{j = 1}^{K} {𝔼}_{q ( {z}_{j} \vert {z}_{0} , {x}_{j} )} [ log p ( {x}_{j} \vert {z}_{j} , {z}_{0} ) + log p ( {z}_{j} \vert {z}_{0} ) - log q ( {z}_{j} \vert {z}_{0} , {x}_{j} ) ] ] + {𝔼}_{q ( {z}_{0} \vert {x}_{1 : K} )} [ log p ( {z}_{0} ) - log q ( {z}_{0} \vert {x}_{1 : K} ) ] \qquad Equation 2$$

where [symbol] may represent an expectation operator, p may represent a probability distribution, q may represent an approximate posterior distribution, z₀ may represent a modality-agnostic latent variable that encodes information shared across all modalities, and zⱼ may represent a modality-specific latent variable that encodes information specific to modality j.

[symbol] ᵢₘₚᵤₜₑ may comprise a loss function that incentivizes the multi-modal generative machine learning model to impute missing modalities based on observed modalities. In some embodiments, [symbol] ᵢₘₚᵤₜₑ may be determined by the following equation:

$${ℒ}_{impute} = {\sum }_{i ∈ I} {𝔼}_{p ( {z}_{i} \vert {z}_{0} ) q ( {z}_{0} \vert {x}_{¬ I} )} [ log p ( {x}_{i} \vert {z}_{i} , {z}_{0} ) ] \qquad Equation 3$$

where I may represent a set of one or more modalities that are missing and ¬I may represent a set of one or more modalities that are observed. In some embodiments, gradient-based optimization routines may be employed where at every iteration, a subset of modalities may be randomly chosen to be treated as missing (e.g., masking) when determining [symbol] ᵢₘₚᵤₜₑ.

In some embodiments, a multi-modal generative machine learning model comprises (i) a modality-agnostic latent variable encoder configured to generate one or more modality-agnostic latent variables based on training data and (ii) one or more modality-specific latent variable encoders configured to (a) receive the one or more modality-agnostic latent variables as input and (b) generate one or more modality-specific latent variables based on one or more modality observation variables (e.g., observed modalities) associated with a plurality of training data elements and the one or more modality-agnostic latent variables. In some embodiments, a multi-modal generative machine learning model comprises a variational autoencoder architecture.

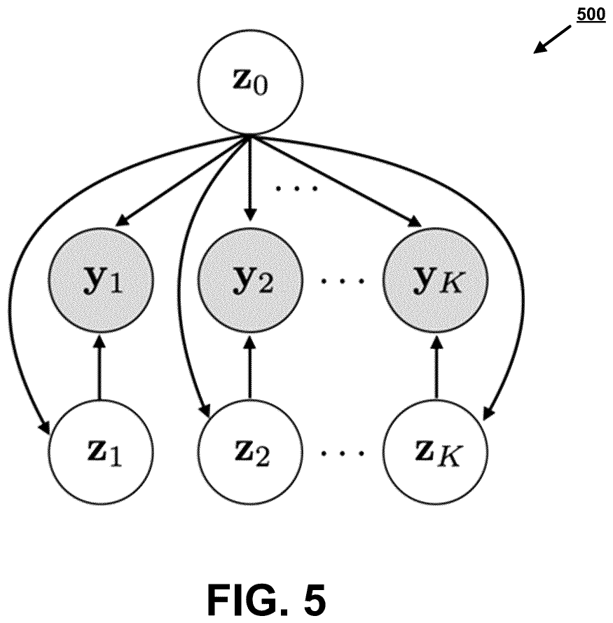

FIG. 5 is an example architecture of a multi-modal generative machine learning model 500 in accordance with some embodiments discussed herein. As further depicted in FIG. 5, the multi-modal generative machine learning model 500 comprises a modality-agnostic latent variable encoder z₀ associated with a plurality of observed modalities y_{1, 2 . . . k}. The multi-modal generative machine learning model 500 further comprises a plurality of modality-specific latent variable encoders z_{1, 2 . . . k}. Each of the modality-specific latent variable encoders z_{1, 2 . . . k} comprises its own individual encoder network that receives as input, output of the modality-agonistic latent variable encoder zo. Via the modality-specific latent variables z_{1, 2 . . . k}, the multi-modal generative machine learning model is able to capture information relevant for a specific modality, leading to better reconstruction/generation of the specific modality. The architecture of multi-modal generative machine learning model 500 may also allow the multi-modal generative machine learning model 500 to better factorize information into modality-agnostic and modality-specific latent information, leading to better sharing of general modality-agnostic information across modalities.

Returning to FIG. 4, in some embodiments, at step/operation 410, the computing entity 200 initiates the performance of one or more training operations based on the loss. In some embodiments, the one or more training operations comprise generating one or more encodings that transform training data into a lower-dimensional feature vector space. In some embodiments, the one or more training operations comprise generating the one or more encodings based on one or more modality-agnostic latent variables and one or more modality-specific latent variables, while optimizing a loss function.

In some embodiments, the one or more training operations comprise optimizing a loss using a loss function. In some embodiments, the loss function defines an aggregate loss comprising a modified ELBO loss that is based on an impute loss. In some embodiments, the modified ELBO loss is defined by an expectation operator, a probability distribution, an approximate posterior distribution, one or more modality-agnostic latent variables, and one or more modality-specific latent variables. In some embodiments, an impute loss comprises a reward that incentivizes an imputation of a subset of missing modalities using a subset of observed modalities within a training dataset. In some embodiments, the impute loss is optimized over a plurality of iterations and, at each iteration of the plurality of iterations, the subset of missing modalities is randomly chosen.

In some embodiments, training a multi-modal generative machine learning model may further comprise modality-specific masking that causes the multi-modal generative machine learning model to leverage observed modalities, thereby allowing the multi-modal generative machine learning model to perform imputation of missing modalities at inference time. In some embodiments, modality-specific masking may be performed on each modality with equal probability. In some embodiments, specific modalities may be masked more frequently if they are more likely to be missing at inference time (e.g., lab results may be masked more frequently than diagnosis codes as labs are more likely to be missing than diagnosis codes). Modality-specific masking probability may be configured by varying an associated hyperparameter of the multi-modal generative machine learning model.

According to various embodiments of the present disclosure, a multi-modal generative machine learning model is used to generate predictions of missing data by: (i) receiving, using the multi-modal generative machine learning model, an input data record comprising a plurality of input data elements, (ii) generating, using the multi-modal generative machine learning model, one or more modality predictions based on one or more modality-specific latent variables and one or more modality-agnostic latent variables (or one or more encodings based thereof), and (iii) initiating the performance of one or more prediction-based actions based on the one or more modality predictions. In some embodiments, an input data element of the plurality of input data elements comprises a missing modality element and the one or more modality predictions comprise a synthetic modality element imputed for the missing modality element. In some embodiments, the one or more modality predictions comprise one or more synthetic data records, each comprising a plurality of synthetic modality elements.

In some embodiments, a modality prediction describes an output generated by a multi-modal generative machine learning model. In some embodiments, a modality prediction comprises an imputation of one or more missing modalities. An imputation of a missing modality may comprise generating a modality that is representative of an estimate of the missing modality. In some embodiments, impute or imputation refers to a generation or reconstruction of data or modalities. For example, a data record may comprise one or more missing modalities that may be replaced, e.g., using a multi-modal generative machine learning model, with a modality prediction comprising one or more imputed modalities based on observed modalities (e.g., from training data). In some example embodiments, a modality prediction may be generated for a patient data record comprising diagnosis code data but not lab result data where the observed data (diagnosis codes) may be leveraged by a multi-modal generative machine learning model to generate an estimate of what lab results may be for the patient data record if lab testing had been performed.

In some embodiments, generating one or more modality predictions comprises providing a multi-modal generative machine learning model with an input comprising a data record list of length K comprising j elements where each element is either (i) a tuple comprising a tensor of shape N×Dⱼ (N representing a number of desired imputation examples to generate, and Dⱼ representing a dimension of modality j) and a ‘1’ to signify an observed modality or (ii) a tuple comprising dummy data and a ‘0’ to signify an unobserved modality (e.g., to be imputed). Based on the input, the multi-modal generative machine learning model may generate a modality prediction comprising an output data record list of length K where observed modalities are preserved while unobserved modalities are replaced with estimated/expected modalities.

In some embodiments, a modality prediction comprises one or more synthetic data records comprising one or more synthetic modalities. A synthetic data record may comprise a data record representative of an example data record and estimates of one or more modalities that may be typical or expected, as determined by a trained multi-modal generative machine learning model.

In some embodiments, generating one or more modality predictions comprises providing a multi-modal generative machine learning model with an input comprising a N number of desired synthetic examples to generate. The multi-modal generative machine learning model may generate a modality prediction comprising a data record list of length K comprising element j, where element j comprises a matrix of shape N×Dⱼ, where Dⱼ may represent a dimension of modality j.

In some embodiments, the performance of one or more prediction-based actions is initiated based on the one or more modality predictions. The one or more prediction-based actions may comprise, for example, generating a diagnostic report, displaying/providing resources, generating, and/or executing action scripts, generating alerts or reminders, or generating one or more electronic communications based on the one or more modality predictions. In yet another example, a prediction-based action may comprise usage of the one or more modality predictions as input of one or more of a downstream application, process, or machine learning model. The one or more prediction-based actions may further include displaying visual renderings of the aforementioned examples of prediction-based actions in addition to values, charts, and representations associated with the one or more modality predictions using a prediction output user interface.

Accordingly, as described above, various embodiments of the present disclosure make important technical contributions to predictive multi-modal data imputation that address the shortcomings of existing generative machine learning models. That is, some techniques of the present disclosure improve the predictive accuracy of predictive machine learning models used in generating modality predictions for modalities missing from data records by training the predictive machine learning models to generate predictions for one or more missing modalities based on observed modalities. This approach improves training speed and training efficiency of training predictive machine learning models. It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative machine learning model architectures. Accordingly, some of the techniques of the present disclosure that improve predictive accuracy without harming training speed, such as the techniques described herein, enable improving training speed given an improved predictive accuracy. In doing so, some of the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

Some techniques of the present disclosure enable the generation or imputation of modalities that are missing from input data records used in prediction tasks for initiating one or more predictive actions to achieve real-world effects. The multi-modal generative machine learning model training techniques of the present disclosure may be used, applied, and/or otherwise leveraged to generate a multi-modal generative machine learning model, which may be used to pre-process data records that may be missing data or modalities for further downstream processing. The multi-modal generative machine learning model of the present disclosure may be leveraged to improve the performance of a computing system (e.g., a computer itself, etc.) with respect to various predictive actions performed by the computing entity 200 by pre-processing data records that may be missing modalities or generating synthetic data records for downstream processing, analysis, predictions, and/or the like. Example predictive actions may include generating a diagnostic report, displaying/providing resources, generating, and/or executing action scripts, generating alerts or reminders, or generating one or more electronic communications based on one or more modality predictions that are generated using a multi-modal generative machine learning model. For instance, one or more modality predictions may be used as input data for generating predictions to determine a predictive action for addressing a concern and automatically initiating the predictive action.

In some examples, the computing tasks may include predictive actions that may be based on a prediction domain. A prediction domain may include any environment in which computing systems may be applied to achieve real-word insights, such as predictions (e.g., abstractive summaries, predictive intents, etc.), and initiate the performance of computing tasks, such as predictive actions e.g., updating user preferences, providing account information, cancelling an account, adding an account, etc.) to act on the real-world insights. These predictive actions may cause real-world changes, for example, by controlling a hardware component, providing alerts, interactive actions, and/or the like.

A predictive action may depend on the prediction domain. Examples of prediction domains may include financial systems, clinical systems, autonomous systems, robotic systems, and/or the like. Predictive actions in such domains may include the initiation of automated instructions across and between devices, automated notifications, automated scheduling operations, automated precautionary actions, automated security actions, automated data processing actions, automated data compliance actions, automated data access enforcement actions, automated adjustments to computing and/or human data access management, and/or the like.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising receiving, by one or more processors, training data comprising a plurality of data elements that comprise (i) a plurality of data values associated with a plurality of training modalities and (ii) a plurality of modality observation variables that each identify an observation of a training modality for a data element of the plurality of data elements; generating, by the one or more processors and using a modality-agnostic latent variable encoder of a multi-modal generative machine learning model, one or more modality-agnostic latent variables based on the plurality of data values; generating, by the one or more processors and using a modality-specific latent variable encoder of the multi-modal generative machine learning model, one or more modality-specific latent variables based on the plurality of modality observation variables and the one or more modality-agnostic latent variables; generating, by the one or more processors and using a loss function, a loss for the multi-modal generative machine learning model based on the one or more modality-agnostic latent variables and the one or more modality-specific latent variables; and initiating, by the one or more processors, the performance of one or more training operations based on the loss.

Example 2. The computer-implemented method of example 1, wherein the multi-modal generative machine learning model comprises a variational autoencoder architecture.

Example 3. The computer-implemented method of any of the preceding examples, further comprising receiving, using the multi-modal generative machine learning model, an input data record comprising a plurality of input data elements; generating, using the multi-modal generative machine learning model, one or more modality predictions based on the one or more modality-specific latent variables and the one or more modality-agnostic latent variables; and initiating the performance of one or more prediction-based actions based on the one or more modality predictions.

Example 4. The computer-implemented method of example 3, wherein an input data element of the plurality of input data elements comprises a missing modality element and the one or more modality predictions comprise a synthetic modality element imputed for the missing modality element.

Example 5. The computer-implemented method of any of examples 3 or 4, wherein the one or more modality predictions comprise one or more synthetic data records, each comprising a plurality of synthetic modality elements.

Example 6. The computer-implemented method of any of the preceding examples, wherein the one or more training operations comprise optimizing the loss using the loss function.

Example 7. The computer-implemented method of example 6, wherein the loss function defines an aggregate loss comprising a modified evidence lower bound (ELBO) loss that is based on an impute loss.

Example 8. The computer-implemented method of example 7, wherein the modified ELBO loss is defined by an expectation operator, a probability distribution, an approximate posterior distribution, the one or more modality-agnostic latent variables, and the one or more modality-specific latent variables.

Example 9. The computer-implemented method of any of examples 7 or 8, wherein the impute loss comprises a reward that incentivizes an imputation of a subset of missing modalities using a subset of observed modalities within a training dataset.

Example 10. The computer-implemented method of example 9, wherein the impute loss is optimized over a plurality of iterations and, at each iteration of the plurality of iterations, the subset of missing modalities is randomly chosen.

Example 11. A computing system comprising memory and one or more processors communicatively coupled to the memory, the one or more processors configured to receive training data comprising a plurality of data elements that comprise (i) a plurality of data values associated with a plurality of training modalities and (ii) a plurality of modality observation variables that each identify an observation of a training modality for a data element of the plurality of data elements; generate, using a modality-agnostic latent variable encoder of a multi-modal generative machine learning model, one or more modality-agnostic latent variables based on the plurality of data values; generate, using a modality-specific latent variable encoder of the multi-modal generative machine learning model, one or more modality-specific latent variables based on the plurality of modality observation variables and the one or more modality-agnostic latent variables; generate, using a loss function, a loss for the multi-modal generative machine learning model based on the one or more modality-agnostic latent variables and the one or more modality-specific latent variables; and initiate the performance of one or more training operations based on the loss.

Example 12. The computing system of example 11, wherein the one or more processors are further configured to receive, using the multi-modal generative machine learning model, an input data record comprising a plurality of input data elements; generate, using the multi-modal generative machine learning model, one or more modality predictions based on the one or more modality-specific latent variables and the one or more modality-agnostic latent variables; and initiate the performance of one or more prediction-based actions based on the one or more modality predictions.

Example 13. The computing system of example 12, wherein an input data element of the plurality of input data elements comprises a missing modality element and the one or more modality predictions comprise a synthetic modality element imputed for the missing modality element.

Example 14. The computing system of any of examples 11 through 13, wherein the one or more processors are further configured to optimize the loss using the loss function.

Example 15. The computing system of example 14, wherein the loss function defines an aggregate loss comprising a modified evidence lower bound (ELBO) loss that is based on an impute loss.

Example 16. The computing system of example 15, wherein the modified ELBO loss is defined by an expectation operator, a probability distribution, an approximate posterior distribution, the one or more modality-agnostic latent variables, and the one or more modality-specific latent variables.

Example 17. One or more non-transitory computer-readable storage media including instructions that, when executed by one or more processors, cause the one or more processors to receive training data comprising a plurality of data elements that comprise (i) a plurality of data values associated with a plurality of training modalities and (ii) a plurality of modality observation variables that each identify an observation of a training modality for a data element of the plurality of data elements; generate, using a modality-agnostic latent variable encoder of a multi-modal generative machine learning model, one or more modality-agnostic latent variables based on the plurality of data values; generating, by the one or more processors and using a modality-specific latent variable encoder of the multi-modal generative machine learning model, one or more modality-specific latent variables based on the plurality of modality observation variables and the one or more modality-agnostic latent variables; generate, using a loss function, a loss for the multi-modal generative machine learning model based on the one or more modality-agnostic latent variables and the one or more modality-specific latent variables; and initiate the performance of one or more training operations based on the loss.

Example 18. The one or more non-transitory computer-readable storage media of example 17, further including instructions that, when executed by the one or more processors, cause the one or more processors to receive, using the multi-modal generative machine learning model, an input data record comprising a plurality of input data elements; generate, using the multi-modal generative machine learning model, one or more modality predictions based on the one or more modality-specific latent variables and the one or more modality-agnostic latent variables; and initiate the performance of one or more prediction-based actions based on the one or more modality predictions.

Example 19. The one or more non-transitory computer-readable storage media of example 18, wherein the one or more modality predictions comprise one or more synthetic data records, each comprising a plurality of synthetic modality elements.

Example 20. The one or more non-transitory computer-readable storage media of any of examples 17 through 19, further including instructions that, when executed by the one or more processors, cause the one or more processors to optimize the loss using the loss function.

Example 21. A computer-implemented method comprising: receiving, by one or more processors, an input data record comprising a plurality of input data elements; generating, by the one or more processors and via a multi-modal generative machine learning model that is applied to the input data record, one or more modality predictions based on (i) one or more modality-agnostic latent variables that are based on a plurality of data values associated with a plurality of training modalities and (ii) one or more modality-specific latent variables that are based on a plurality of modality observation variables and the one or more modality-agnostic latent variables; and initiating, by the one or more processors, the performance of one or more prediction-based actions based on the one or more modality predictions.

Example 22. The computer-implemented method of example 21, wherein an input data element of the plurality of input data elements comprises a missing modality element and the one or more modality predictions comprise a synthetic modality element imputed for the missing modality element.

Example 23. The computer-implemented method of example 21, wherein the one or more modality predictions comprise one or more synthetic data records, each comprising a plurality of synthetic modality elements.

Example 24. The computer-implemented method of example 21, wherein the multi-modal generative machine learning model is trained by optimizing a loss using a loss function that is based on an impute loss.

Example 25. The computer-implemented method of example 1 or 21, wherein the multi-modal generative machine learning model comprises one or more variational autoencoders and the method further comprises training, using one or more gradient-based optimization routines, the multi-modal generative machine learning model to optimize the loss.

Example 26. The computer-implemented method of example 25, wherein the training is performed by the one or more processors.

Example 27. The computer-implemented method of example 25, wherein the one or more processors are included in a first computing entity; and the training is performed by one or more other processors included in a second computing entity.

Example 28. The computer-implemented method of example 3, wherein the one or more processors are included in a first computing entity; and the generating of the one or more modality predictions is performed by one or more other processors included in a second computing entity.

Example 29. The computing system of example 11, wherein the multi-modal generative machine learning model comprises one or more variational autoencoders and the method further comprises training, using one or more gradient-based optimization routines, the multi-modal generative machine learning model to optimize the loss.

Example 30. The computing system of example 29, wherein the training is performed by the one or more processors.

Example 31. The computing system of example 29, wherein the one or more processors are included in a first computing entity; and the training is performed by one or more other processors included in a second computing entity.

Example 32. The computing system of example 12, wherein the one or more processors are included in a first computing entity; and the generating of the one or more modality predictions is performed by one or more other processors included in a second computing entity.

Example 33. The one or more non-transitory computer-readable storage media of example 17, wherein the multi-modal generative machine learning model comprises one or more variational autoencoders and the method further comprises training, using one or more gradient-based optimization routines, the multi-modal generative machine learning model to optimize the loss.

Example 34. The one or more non-transitory computer-readable storage media of example 33, wherein the training is performed by the one or more processors.

Example 35. The one or more non-transitory computer-readable storage media of example 33, wherein the one or more processors are included in a first computing entity; and the training is performed by one or more other processors included in a second computing entity.

Example 36. The one or more non-transitory computer-readable storage media of example 18, wherein the one or more processors are included in a first computing entity; and the generating of the one or more modality predictions is performed by one or more other processors included in a second computing entity.

1. A computer-implemented method comprising:
receiving, by one or more processors, training data comprising a plurality of data elements that comprise (i) a plurality of data values associated with a plurality of training modalities and (ii) a plurality of modality observation variables that each identify an observation of a training modality for a data element of the plurality of data elements;
generating, by the one or more processors and using a modality-agnostic latent variable encoder of a multi-modal generative machine learning model, one or more modality-agnostic latent variables based on the plurality of data values;
generating, by the one or more processors and using a modality-specific latent variable encoder of the multi-modal generative machine learning model, one or more modality-specific latent variables based on the plurality of modality observation variables and the one or more modality-agnostic latent variables;
generating, by the one or more processors and using a loss function, a loss for the multi-modal generative machine learning model based on the one or more modality-agnostic latent variables and the one or more modality-specific latent variables; and
initiating, by the one or more processors, the performance of one or more training operations based on the loss.

2. The computer-implemented method of claim 1, wherein the multi-modal generative machine learning model comprises a variational autoencoder architecture.

3. The computer-implemented method of claim 1 further comprising:
receiving, using the multi-modal generative machine learning model, an input data record comprising a plurality of input data elements;
generating, using the multi-modal generative machine learning model, one or more modality predictions based on the one or more modality-specific latent variables and the one or more modality-agnostic latent variables; and
initiating the performance of one or more prediction-based actions based on the one or more modality predictions.

4. The computer-implemented method of claim 3, wherein an input data element of the plurality of input data elements comprises a missing modality element and the one or more modality predictions comprise a synthetic modality element imputed for the missing modality element.

5. The computer-implemented method of claim 3, wherein the one or more modality predictions comprise one or more synthetic data records, each comprising a plurality of synthetic modality elements.

6. The computer-implemented method of claim 1, wherein the one or more training operations comprises optimizing the loss using the loss function.

7. The computer-implemented method of claim 6, wherein the loss function defines an aggregate loss comprising a modified evidence lower bound (ELBO) loss that is based on an impute loss.

8. The computer-implemented method of claim 7, wherein the modified ELBO loss is defined by an expectation operator, a probability distribution, an approximate posterior distribution, the one or more modality-agnostic latent variables, and the one or more modality-specific latent variables.

9. The computer-implemented method of claim 7, wherein the impute loss comprises a reward that incentivizes an imputation of a subset of missing modalities using a subset of observed modalities within a training dataset.

10. The computer-implemented method of claim 9, wherein the impute loss is optimized over a plurality of iterations and, at each iteration of the plurality of iterations, the subset of missing modalities is randomly chosen.

11. A computing system comprising memory and one or more processors communicatively coupled to the memory, the one or more processors configured to:
receive training data comprising a plurality of data elements that comprise (i) a plurality of data values associated with a plurality of training modalities and (ii) a plurality of modality observation variables that each identify an observation of a training modality for a data element of the plurality of data elements;
generate, using a modality-agnostic latent variable encoder of a multi-modal generative machine learning model, one or more modality-agnostic latent variables based on the plurality of data values;
generate, using a modality-specific latent variable encoder of the multi-modal generative machine learning model, one or more modality-specific latent variables based on the plurality of modality observation variables and the one or more modality-agnostic latent variables;
generate, using a loss function, a loss for the multi-modal generative machine learning model based on the one or more modality-agnostic latent variables and the one or more modality-specific latent variables; and
initiate the performance of one or more training operations based on the loss.

12. The computing system of claim 11, wherein the one or more processors are further configured to:
receive, using the multi-modal generative machine learning model, an input data record comprising a plurality of input data elements;
generate, using the multi-modal generative machine learning model, one or more modality predictions based on the one or more modality-specific latent variables and the one or more modality-agnostic latent variables; and
initiate the performance of one or more prediction-based actions based on the one or more modality predictions.

13. The computing system of claim 12, wherein an input data element of the plurality of input data elements comprises a missing modality element and the one or more modality predictions comprise a synthetic modality element imputed for the missing modality element.

14. The computing system of claim 11, wherein the one or more processors are further configured to optimize the loss using the loss function.

15. The computing system of claim 14, wherein the loss function defines an aggregate loss comprising a modified evidence lower bound (ELBO) loss that is based on an impute loss.

16. The computing system of claim 15, wherein the modified ELBO loss is defined by an expectation operator, a probability distribution, an approximate posterior distribution, the one or more modality-agnostic latent variables, and the one or more modality-specific latent variables.

17. A computer-implemented method comprising:
receiving, by one or more processors, an input data record comprising a plurality of input data elements;
generating, by the one or more processors and via a multi-modal generative machine learning model that is applied to the input data record, one or more modality predictions based on (i) one or more modality-agnostic latent variables that are based on a plurality of data values associated with a plurality of training modalities and (ii) one or more modality-specific latent variables that are based on a plurality of modality observation variables and the one or more modality-agnostic latent variables; and
initiating, by the one or more processors, the performance of one or more prediction-based actions based on the one or more modality predictions.

18. The computer-implemented method of claim 17, wherein an input data element of the plurality of input data elements comprises a missing modality element and the one or more modality predictions comprise a synthetic modality element imputed for the missing modality element.

19. The computer-implemented method of claim 17, wherein the one or more modality predictions comprise one or more synthetic data records, each comprising a plurality of synthetic modality elements.

20. The computer-implemented method of claim 17, wherein the multi-modal generative machine learning model is trained by optimizing a loss using a loss function that is based on an impute loss.
